(19) United States
(12) Patent Application Publication
(10) Pub. No.: US 2016/0097641 A1
(43) Pub. Date: Apr. 7, 2016

(54) Sensors Including Ionic Liquids and Methods of Making and Using the Same

(71) Applicants: Lenore L. Dai, Phoenix, AZ (US); Hongyu Yu, Chandler, AZ (US); Miranda Ngan, Chandler, AZ (US); Mengbing Liang, Mesa, AZ (US); Hai Huang, Sunnyvale, CA (US); Denzil Frost, Hillsboro, OR (US); Stella Nickerson, Scottsdale, AZ (US)

(72) Inventors: Lenore L. Dai, Phoenix, AZ (US); Hongyu Yu, Chandler, AZ (US); Miranda Ngan, Chandler, AZ (US); Mengbing Liang, Mesa, AZ (US); Hai Huang, Sunnyvale, CA (US); Denzil Frost, Hillsboro, OR (US); Stella Nickerson, Scottsdale, AZ (US)

(21) Appl. No.: 14/874,061

(22) Filed: Oct. 2, 2015

Related U.S. Application Data
(60) Provisional application No. 62/059,482, filed on Oct. 3, 2014.

(51) Int. Cl. G01C 19/5705

(52) U.S. Cl. CPC G01C 19/5705

(57) ABSTRACT

A system and method for using a sensor includes a first anode and cathode pair having a first non-zero voltage therebetween and an ionic liquid contacting the first anode and cathode pair. An output is provided that communicates a motion sense signal corresponding to a motion or pressure of the sensor in at least one direction that causes a change in a first ionic concentration gradient between the first anode and cathode pair.

### CROSS-REFERENCE TO RELATED APPLICATIONS

This application is based on, claims priority to, and incorporates herein by references for all purposes U.S. Provisional Patent Application No. 62/059,482, filed Oct. 3, 2014.

### STATEMENT REGARDING FEDERALLY SPONSORED RESEARCH

This invention was made with government support under 0922277 awarded by the National Science Foundation and NNX10AL25G awarded by the National Aeronautical & Space Administration. The government has certain rights in the invention.

### BACKGROUND

The present disclosure relates to system and methods for motion or pressure sensing and for systems and methods for manufacturing and using motion or pressure sensing systems. More particularly, the disclosure relates to systems and methods of sensing motion and systems and methods for creating and using systems for motion sensing using an accelerometer or gyroscope or hydrophone.

Inertial sensors with small size, low noise, high sensitivity, and wide frequency range are important in a broad range of disciplines, including seismology, consumer electronics, source detection, aviation and navigation. With the advent of smart electronic devices, a huge market promoted the development of inertial sensors. After decades of development, solid-state inertial sensors including silicon based micro-electromechanical system (MEMS) accelerometers, gyroscopes, and hydrophones have dominated the market. Despite the success in market, high complexity and cost in fabrication limited the improvement in reliability and reproducibility.

There are variety of systems that can be used to sense motion. Traditional mass-spring systems are the mechanisms behind the solid-state accelerometers and include a suspended proof mass. This configuration presents an inherent limitation in size and noise floor, which results in suitable function at high frequencies, but poor performance at low frequencies. As opposed to solid-state accelerometers, molecular electronic transducers (MET) motion sensors (e.g. accelerometers and rotational sensors) use a liquid inertial mass to replace the solid inertial mass, which enhances the performance at low frequency. Molecular electronic transducers exhibit good performance at low frequency and have a small size. However, a conventional MET accelerometer uses water based electrolytes as the sensing body. Water-based systems have temperature limits that are limited by the material properties of water due to its evaporation point and freezing point.

Accordingly, it would be beneficial to provide a sensor that overcomes the limitations set forth above.

### SUMMARY

The present disclosure overcomes the aforementioned drawbacks by providing a sensor utilizing an ionic liquid-based electrolyte and methods of making and using the same.

A system and method for using a sensor includes a first anode and cathode pair having a first non-zero voltage therebetween and an ionic liquid contacting the first anode and cathode pair. An output is provided that communicates a motion sense signal corresponding to a motion or pressure of the sensor in at least one direction that causes a change in a first ionic concentration gradient between the first anode and cathode pair.

The foregoing and other aspects and advantages of the disclosure will appear from the following description. In the description, reference is made to the accompanying drawings which form a part hereof, and in which there is shown by way of illustration a preferred aspect of the disclosure. Such aspect does not necessarily represent the full scope of the disclosure, however, and reference is made therefore to the claims and herein for interpreting the scope of the disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a schematic of an ionic liquid based MET accelerometer, in accordance with the present disclosure.

FIG. 2 shows a schematic of an ionic liquid based MET gyroscope, in accordance with the present disclosure.

FIG. 3 shows a schematic of a generic vibratory gyroscope.

FIG. 4 is a flowchart showing a method, in accordance with one aspect of the present disclosure.

FIG. 5 shows a concentration gradient of ions across the electrodes of a MET, in accordance with the present disclosure, before a motion.

FIG. 6 shows a concentration gradient of ions across the electrodes of a MET accelerometer, in accordance with the present disclosure, after a motion in the direction denoted by u.

### DETAILED DESCRIPTION

This disclosure describes an MET sensor using an ionic liquid (for example, ethylammonium nitrate (EAN), 1-butyl-3-methylimidazolium iodide ([bmim] [I]) as the electrolyte (with or without the addition of a metal halide or metal and chalcogen compound, with or without the addition of a liquid containing an OH group to form a low transition temperature mixture (LTTM), and with or without the addition of nanoparticles) to sense the movement caused by acceleration or pressure change and transform it to an electrical signal. The systems and methods provided herein describe a liquid-based sensor with improved stability and sensitivity using an ionic liquid electrolyte, instead of, for example, a KI-in-water solution. An ionic liquid is a salt which exists in a liquid state at a wide range of temperatures. Room temperature ionic liquids (RTILs) in particular have extremely low melting points compared to other salts, and are liquids at or even below room temperature. In recent years, ionic liquids have been used in novel applications as “green” solvents. Although potassium iodide and other metal halides have high solubility in water, enabling high ion concentration and thus high sensitivity to vibration, a water-based electrolyte has various limitations. The operating temperature range is limited to the range at which the salt/water solution is a liquid, and the solution is volatile when exposed to air, requiring capsulation to be used; this increases the complexity and limits the size of droplet structure. As a result, a high performance MET inertial sensor operable over a wide range of frequencies utilizing a novel electrolyte would be much better suited for harsh environments.

This disclosure provides an ionic liquid-based MET inertial sensor, which uses ionic liquid based electrolytes (either pure ionic liquids or ionic liquids supplemented with a metal halide, a compound consisting of a metal and a chalcogen, a solvent including an OH group to form a LTTM, or nanoparticles) to replace water based electrolytes, in order to solve the problem of the limited temperature range of water-based electrolytes. This ionic liquid electrolyte enables new structures based on MET technology, which may include a new design for MET accelerometers, gyroscopes, hydrophones and seismometers. This disclosure includes, without limitation, the following: 1) the MET motion and pressure sensor's working principle based on an ionic liquid; 2) MET accelerometer (including seismometer) design with an ionic liquid droplet; and 3) MET gyroscope design with an ionic liquid droplet; 4) the method of measuring motion and pressure data with the MET using an ionic liquid.

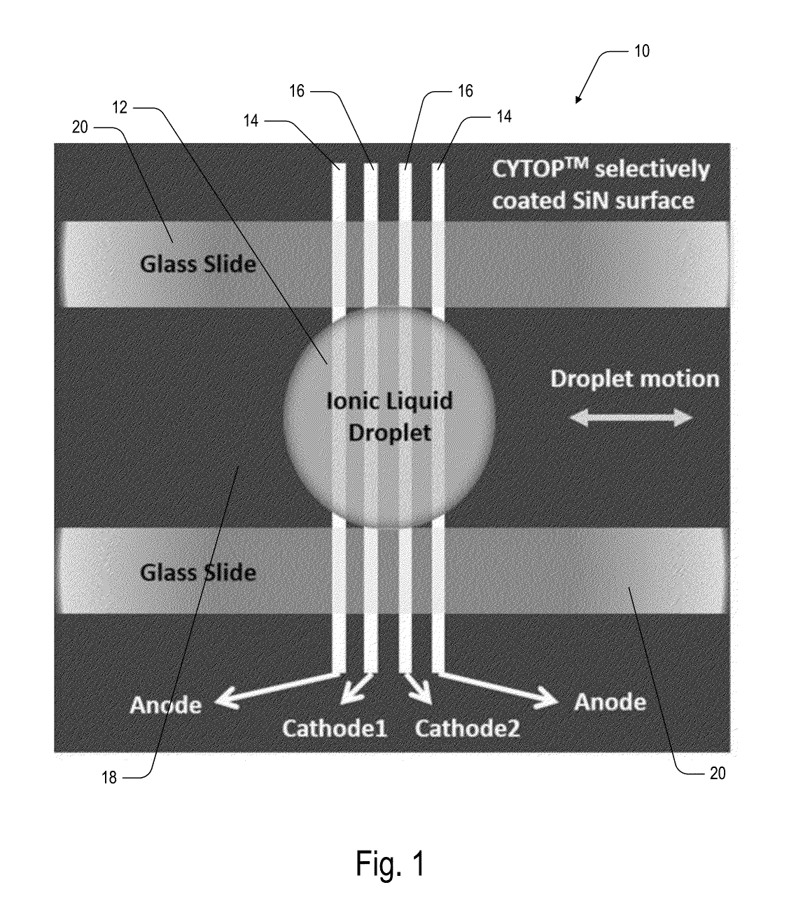

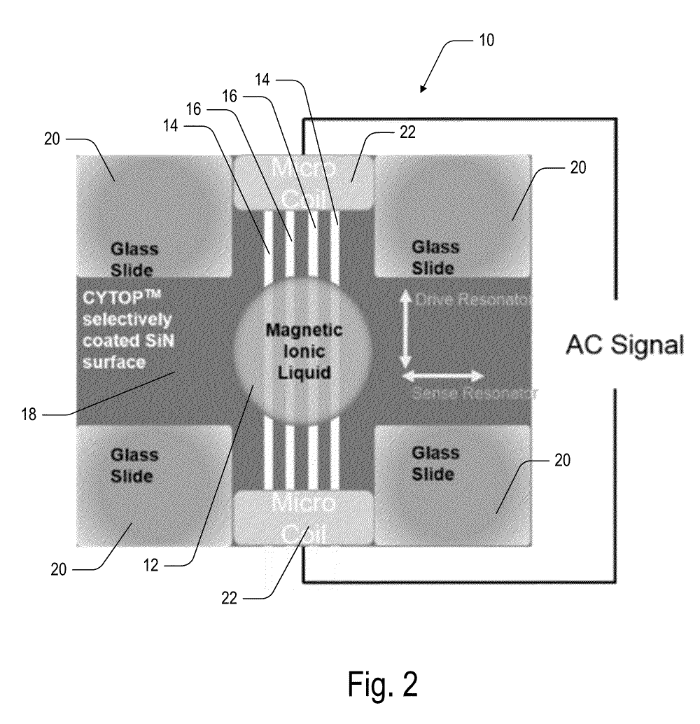

Referring to FIGS. 1 and 2, this disclosure provides a sensor 10. In certain aspects, the sensor 10 can be an accelerometer, a gyroscope, a hydrophone, a seismometer, or a combination thereof. The sensor 10 can be a MET sensor. The sensor 10 can operate with an ionic liquid electrolyte 12.

The sensor can have electrodes (anodes 14 and cathodes 16) positioned atop a substrate 18. The substrate 18 can be coated or uncoated to have chemical properties that provide suitable performance. One example of a coated substrate includes a CYTOPT™ selectively coated SiN substrate, although a person having ordinary skill in the art will appreciate that there are many alternatives, and the specific substrate and/or coating are not intended to limit the scope of the present disclosure.

The sensor can include physical features or structures 20 to confine the ionic liquid to a particular space (such as, a space where the ionic liquid is in contact with the electrodes. The physical features or structures can limit motion in one dimension while allowing motion in a second dimension.

Referring to FIG. 2, the sensor 10 can include a vibrational actuator 22, such as a pair of micro coils coupled to an AC power source.

A sensor, for example an MET accelerometer, can include a first anode and cathode pair, an ionic liquid, and an output. In certain aspects, the first anode and cathode pair can have a first non-zero voltage applied therebetween. The ionic liquid can contact the first anode and cathode pair. The output can communicate a motion sense signal corresponding to a first motion or a first pressure of the sensor in at least one direction that causes a change in a first ionic concentration gradient between the first anode and cathode pair. The sensor can further include a second anode and cathode pair having a second non-zero voltage applied therebetween. The ionic liquid can contact the second anode and cathode pair. The motion sense signal can additionally correspond to a second motion or a second pressure of the sensor in at least one direction that causes a change in a second ionic concentration gradient between the second anode and cathode pair. It should be appreciated that the same motion or pressure can cause a change in the first and second ionic concentration gradient. The first and second motion can be the same or different. The first and second pressure can be the same or different.

In certain aspects, the first anode and cathode pair and the second anode and cathode pair can be arranged substantially parallel to one another, substantially planar to one another, or a combination thereof.

The first or second motion or the first or second pressure can be in a direction perpendicular to the first and second anode and cathode pairs, in a direction along a shared plane of the first and second anode and cathode pairs, or a combination thereof.

Traditional MET accelerometers can include as sensing elements four platinum electrodes, the electrodes in a plane separated by LPCVD Silicon Nitride in parallel distribution, and a water-based sub-microliter electrolyte droplet encapsulated in oil. However, this disclosure uses an ionic liquid based electrolyte droplet to replace the water based droplet and does not require oil encapsulation.

A micromachined gyroscope is a device that measures the rate or angle of rotation around a fixed axis with respect to an inertial space. A variety of different gyroscopes are available that, which are based on angular momentum conservation and the Sagnac and Coriolis effects.

In certain aspects, the MET gyroscope can include a first anode and cathode pair having a first non-zero voltage applied. The first anode and cathode pair can be oriented substantially parallel to a first direction. An ionic liquid can contact the first anode and cathode pair. A vibrational actuator can be configured to vibrate the ionic liquid in this first direction. An output can communicate a motion sense signal corresponding to a first rotational motion of the sensor in at least one rotational direction that causes a change in a first ionic concentration gradient between the first anode and cathode pair. The sensor can further include a second anode and cathode pair having a second non-zero voltage applied. The ionic liquid can contact the second anode and cathode pair. The motion sense signal can additionally correspond to a second rotational motion of the sensor in at least one rotational direction that causes a change in a second ionic concentration gradient between the second anode and cathode pair. It should be appreciated that the same rotational motion can cause a change in the first and second ionic concentration gradient. The first and second rotational motion can be the same or different.

In certain aspects, the first anode and cathode pair and the second anode and cathode pair can be arranged substantially parallel to one another, substantially planar to one another, or a combination thereof.

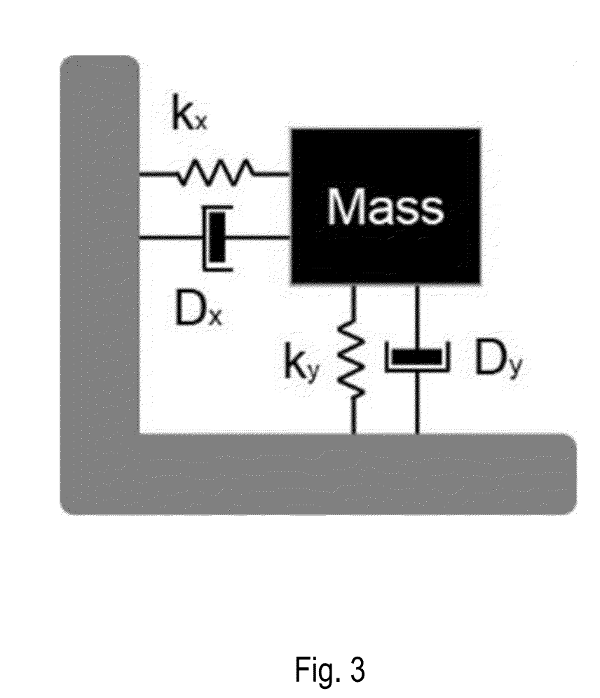

In certain aspects, an MET gyroscope based on an ionic liquid droplet can use the Coriolis Effect, which is a kind of vibratory gyros, via a two axis spring-mass system is developed to generate the vibration and sense the rotation rate according to the Coriolis Effect, as shown schematically in FIG. 3.

The x-directional resonator in a vibratory gyroscope is called the drive resonator which generates a vibration at a constant frequency thereby activating the system. The y-directional resonator in a vibratory gyroscope is called the sense resonator which associates with the vibration of x axis and rotation rate at x direction. When distributing the four electrodes parallel with the x direction, the y-directional resonance could be read out similar to the MET accelerometer. An MET gyroscope employs a drive resonator perpendicular to the sensing direction. The driving force of this resonator can be but is not limited to electrostatic force, magnetic force, and pressure.

One example of this driving mechanism can be magnetic driving. Strategically placed coils and a magnetic ionic liquid droplet, which has properties without resolving magnetic materials, can provide a sinusoidal signal when applying an AC electrical signal to the coils. The small size of the droplet can reduce the interference experienced by virtue of cross-talking between the resonator and MET sensor.

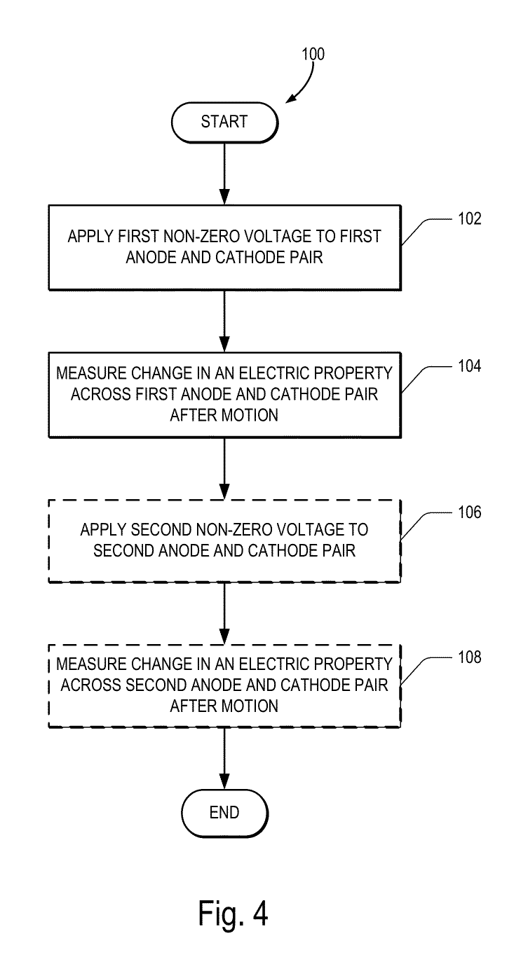

Referring to FIG. 4, this disclosure provides a method 100 of measuring motion or pressure data. At process block 102, the method 100 can include applying a first non-zero voltage to a first anode and cathode pair that is contact by an ionic liquid. The first non-zero voltage can establish a first ionic concentration gradient across the first anode and cathode pair. At process block 104, the method 100 can include measuring a change in an electrical property across the first anode and cathode pair after a motion. At optional process block 106, the method 100 can optionally include applying a second non-zero voltage to a second anode and cathode pair that is contacted by the ionic liquid. At optional process block 108, the method 100 can optionally include measuring a change in an electrical property across the second anode and cathode pair after the motion. Optional process steps 106 and 108 can be performed simultaneously or sequentially with process 102 and 104.

A non-zero gradient can be applied to a first anode and cathode pair that is contacted by a ionic liquid thereby establishing a first ionic concentration gradient across the first anode and cathode pair, while applying a second non-zero voltage to a second anode and cathode pair that is contacted by the ionic liquid thereby establishing a second ionic concentration gradient across the second anode and cathode pair. The first ionic concentration gradient and the second ionic concentration gradient can have a different magnitude, a different directionality, or a combination thereof. A change in an electrical property can be measured across each anode and cathode pair after a motion of the first anode and cathode pair, the ionic liquid, or a combination thereof. That electrical property can be current.

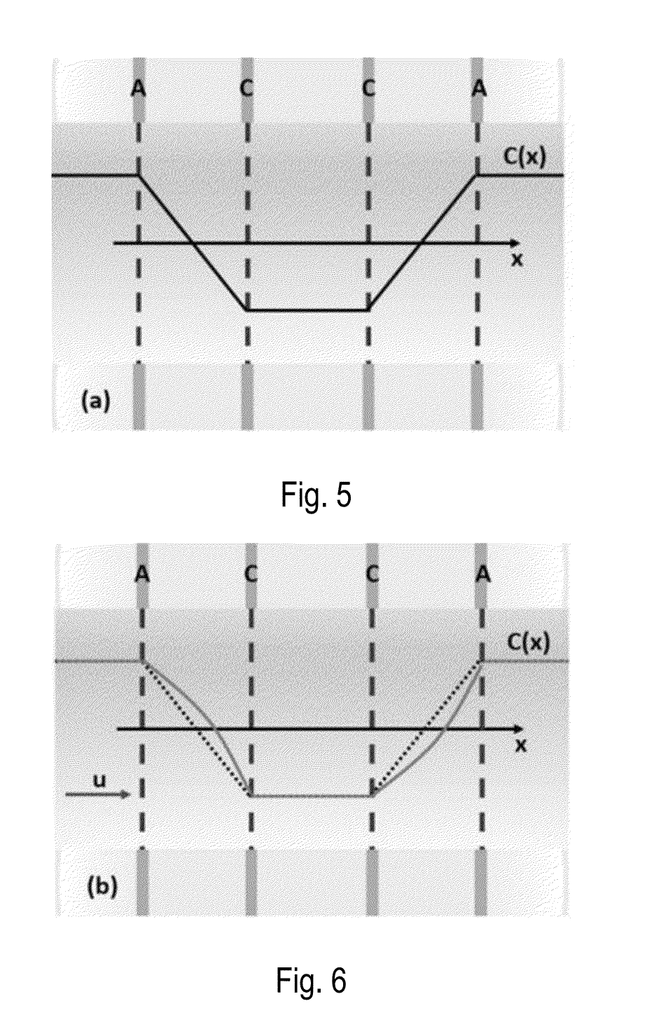

When a voltage is applied to the anode as shown in FIGS. 5 and 6, an electrochemical current at the cathode occurs, which is also called “background current”. This current is independent of the mechanical motion. As a result, electrochemical reactions develop a concentration gradient of the solution components which leads to diffusion of ions from one electrode to another as shown in FIG. 5. When an acceleration is added on the frame, the relative displacement between the frame and the droplet may generate additional convective transport of ions as shown in FIG. 6. As the concentration of the ions on the surface of the electrodes varies, the current between adjacent anode and cathode can be represented by the following:

$$I = Dq ( ( ∇ c , n ) d s )$$

where, D is the diffusion coefficient, c is the concentration of charge carriers, q is the charge of carriers, S is the electrode surface area, n is a unit vector normal to the surface of the electrode.

The differential current experienced by the cathodes after motion can be represented by the following:

$${I}_{out} ( t ) = {I}_{c 2} ( t ) - {I}_{c 1} ( t ) = Dq ( ( ∇ c , n ) d {S}_{c 2} - ( ∇ c , n ) d {S}_{c 1} ) )$$

where S_{c2} and S_{c1} are the surface areas corresponding to the cathodes.

Because each ionic liquid consists of both a cation and an anion, a wide variety of ionic liquids with different properties are possible. Different combinations of cations and anions have different melting and boiling points, different diffusion coefficients, and different viscosities, all of which will have an effect on the performance of the MET sensor.

Ionic liquids are a class of electrolytes that show surprisingly good performance characteristics when used in the MET microseismometer. Ionic liquids are a unique collection of liquid materials composed solely of ions. With a combination of many unique properties, such as negligible volatility, non-flammability, excellent thermal and chemical stability, and high ionic conductivity, as well as potential broad applications, there has been increasing attention in ionic liquids. Low temperature ionic liquid electrolytes may be suitable for use in the sensors described herein, such as MET accelerometers, gyroscopes, hydrophones and seismometers.

In certain aspects, the ionic liquid can include a cation selected from the group consisting of ethylammonium nitrate, 1-butyl-3-methylimidazolium, 1-alkyl-3-methylimidazolium, 1-alkylpyridinium, N-methyl-N-alkylpyrrolidinium, ammonium cations, phosphonium cations, and combinations thereof. The aforementioned cations are not the only cations usable with the present disclosure, but rather, are provided as a non-limiting set of exemplary cations.

In certain aspects, the ionic liquid can include an anion selected from the group consisting of a halide, such as fluoride, chloride, bromide, iodide, or astatide, an inorganic anion, such as tetrafluoroborate or hexafluorophosphate, a large organic anion, such as bistriflimide, triflate, or tosylate, a non-halogenated organic anion, such as formate, alkylsulfate, alkylphosphate, or glycolate, and combinations thereof. The aforementioned anions are not the only anions usable with the present disclosure, but rather, are provided as a non-limiting set of exemplary anions.

In certain aspects, the ionic liquid is an iodide ionic liquid, which features iodide as the anion. Since iodide is the ion involved in iodide/triiodide redox reactions, an iodide ionic liquid electrolyte can increase the concentration of charge carriers in the electrolyte and thus improve the sensitivity of the device. Iodide ionic liquids also have wide liquid temperatures and, in particular, low freezing points. However, iodide ionic liquids are usually high viscosity, which reduces their effectiveness. Indeed, ionic liquids generally exhibit a tradeoff between low viscosity and a wide temperature range. This problem can be solved with the addition of a solvent such as water or lactic acid which features an OH group which can act as a hydrogen bond donor. The ionic liquid then acts as a hydrogen bond acceptor, and the two liquids together form a LTTM with a lower freezing point than either liquid in its pure state. While too much water creates an electrolyte not substantially different than a KI in water solution, smaller amounts of water (or lactic acid, ethylene glycol, etc.) form an electrolyte with unique properties including high ion density, a high ability to dissolve metal halides, and simultaneously low freezing points and viscosities. For example, a mixture of 73% [bmim] [I], 18% water, and 9% Lil (by mass) has an extremely wide temperature range with a melting point of −93° C. and a boiling point of 189° C. This liquid temperature range has been confirmed by differential scanning calorimetry. This mixture also exhibits a high resolution signal in the MET when compared to KI-in-water mixtures.

In certain aspects, the ionic liquid can have a water content of less than 25% by mass, or less than 20% by mass.

The ionic liquid can comprise a material selected from the group consisting of a metal halide, a compound comprising a metal and a chalcogen, and combinations thereof. The ionic liquid can further comprise a material selected from the group consisting of potassium iodide, sodium iodide, lithium iodide, 1-butyl-3-methyl-imidazolium iodide, ethylammonium nitrate, and combinations thereof.

The ionic liquid can also comprise a material having an OH group. In certain aspects, the material having an OH group can be a liquid. Without wishing to be bound by any particular theory, it is believed that addition of the material having an OH group can serve as a hydrogen bond donor, thus providing a low transition temperature mixture with a freezing point that is lower than the ionic liquid in its pure state.

In certain aspects, the ionic liquid can further include nanoparticles. The nanoparticles can be metal nanoparticles of polymer-based nanoparticles. Metal nanoparticles consisting of gold, platinum or palladium can act as catalysts speeding the electrochemical reaction at the electrodes and thus increasing the sensitivity of the MET to convective transfer of ions. Nanoparticles formed of hydrophobic polymers, meanwhile, may reduce noise within the sensor signal by stabilizing the hydrophobic ionic liquid cations.

An output as described herein can include any measurable signal that contains interpretable information. The interpretable information can contain the motion sense signal. The systems and methods described herein can further include any circuits, electronics, processor, and the like that are necessary for processing the output or motion sense signal, as would be appreciated by a person having ordinary skill in the art.

The present disclosure has been described in terms of one or more preferred aspects, and it should be appreciated that many equivalents, alternatives, variations, and modifications, aside from those expressly stated, are possible and within the scope of the disclosure.

We claim:

1. A sensor comprising:
a first anode and cathode pair having a first non-zero voltage therebetween;
an ionic liquid contacting the first anode and cathode pair, and
an output communicating a motion sense signal corresponding to a first motion or a first pressure of the sensor in at least one direction that causes a change in a first ionic concentration gradient between the first anode and cathode pair.

2. The sensor of claim 1, the sensor further comprising a second anode and cathode pair having a second non-zero voltage applied;
the ionic liquid contacting the second anode and cathode pair; and
the motion sense signal additionally corresponding to a second motion or a second pressure of the sensor in at least one direction that causes a change in a second ionic concentration gradient between the second anode and cathode pair.

3. The sensor of claim 2, wherein the first anode and cathode pair and the second anode and cathode pair are arranged substantially parallel to one another, substantially planar to one another, or a combination thereof.

4. The sensor of claim 3, wherein the first or second motion or the first or second pressure of the sensor is in a direction perpendicular to the first and second anode and cathode pairs, in a direction along a shared plane of the first and second anode and cathode pairs, or a combination thereof.

5. The sensor of claim 1, wherein the ionic liquid comprises a material selected from the group consisting of a metal halide, a compound comprising a metal and a chalcogen, and combinations thereof.

6. The sensor of claim 1, wherein the ionic liquid comprises a material selected from the group consisting of potassium iodide, sodium iodide, lithium iodide, 1-butyl-3-methyl-imidazolium iodide, ethylammonium nitrate, and combinations thereof.

7. A sensor comprising:
a first anode and cathode pair having a first non-zero voltage applied, the first anode and cathode pair being oriented substantially parallel to a first direction;
an ionic liquid contacting the first anode and cathode pair;
a vibrational actuator configured to vibrate the ionic liquid in the first direction, and
an output communicating a motion sense signal corresponding to a first rotational motion of the sensor in at least one rotational direction that causes a change in a first ionic concentration gradient between the first anode and cathode pair.

8. The sensor of claim 7, the sensor further comprising a second anode and cathode pair having a second non-zero voltage applied;
the ionic liquid contacting the second anode and cathode pair; and
the motion sense signal additionally corresponding to a second rotational motion of the sensor in at least one rotational direction that causes a change in a second ionic concentration gradient between the second anode and cathode pair.

9. The sensor of claim 8, wherein the first anode and cathode pair and the second anode and cathode pair are arranged substantially parallel to one another, substantially planar to one another, or a combination thereof.

10. The sensor of claim 7, wherein the ionic liquid comprises a material selected from the group consisting of a metal halide, a compound comprising a metal and a chalcogen, and combinations thereof.

11. The sensor of claim 10, wherein the ionic liquid comprises a material selected from the group consisting of potassium iodide, sodium iodide, ethylammonium nitrate, and combinations thereof.

12. The sensor of claim 7, the ionic liquid comprising a material having an OH group.

13. The sensor of claim 7, the ionic liquid comprising metallic or polymer-based nanoparticles.

15. A method of measuring motion or pressure data, the method comprising:
a) applying a first non-zero voltage to a first anode and cathode pair that is contacted by an ionic liquid thereby establishing a first ionic concentration gradient across the first anode and cathode pair;
b) measuring a change in an electrical property across the first anode and cathode pair after a motion of the first anode and cathode pair, the ionic liquid, or a combination thereof.

16. The method of claim 15, the method further comprising:
a1) applying a second non-zero voltage to a second anode and cathode pair that is contacted by the ionic liquid thereby establishing a second ionic concentration gradient across the second anode and cathode pair; and
b1) measuring a change in an electrical property across the second anode and cathode pair after a motion of the second anode and cathode pair, the ionic liquid, or a combination thereof.

17. The method of claim 16, wherein the first ionic concentration gradient and the second ionic concentration gradient have a different magnitude, a different directionality, or a combination thereof.

18. The method of claim 15, wherein the electrical property is current.

19. The method of claim 15, wherein the ionic liquid comprises a material selected from the group consisting of a metal halide, a compound comprising a metal and chalcogen, and combinations thereof.

20. The method of claim 19, wherein the ionic liquid comprises a material selected from the group consisting of potassium iodide, sodium iodide, lithium iodide, 1-butyl-3-methyl-imidazolium iodide, ethylammonium nitrate, and combinations thereof.
